(19) United States
(12) Patent Application Publication
(10) Pub. No.: US 2008/0080547 A1
(43) Pub. Date: Apr. 3, 2008

(54) SYSTEM AND METHOD FOR FORMING A TIME DIVISION MULTIPLE ACCESS FRAME IN A SIMULCAST SYSTEM

(75) Inventors: DANIEL J. FEIERTAG, FOREST PARK, IL (US); MICHAEL C. PETRIE, HOFFMAN ESTATES, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/536,879

(22) Filed: Sep. 29, 2006

(51) Int. Cl. H04B 7/212; H04L 12/43

(52) U.S. Cl. 370/442; 370/458

(57) ABSTRACT

A method for efficiently forming a time division multiple access (TDMA) frame for transmission in a simulcast system is disclosed, wherein the TDMA frame comprises a plurality of timeslots and sub-slots. At a prime site, a first communication grant is received that assigns a first communication to a first timeslot from the plurality of timeslots in the TDMA frame. A transmission time is generated for the first timeslot in the TDMA frame, and sub-slot information is generated to be transmitted in the plurality of sub-slots. A first bundle is formed which includes the transmission time, a burst from the communication to be transmitted in the first timeslot, and a portion of the sub-slot information to be transmitted in a first sub-slot. The first bundle is then sent to a plurality of remote sites in preparation for transmission of the TDMA frame to a communication unit in the simulcast system.

### TECHNICAL FIELD OF THE INVENTION

This invention relates generally to simulcast communication systems, and more particularly, to a system and method for forming a time division multiple access (TDMA) frame in a simulcast system.

### BACKGROUND OF THE INVENTION

Wireless communication systems generally employ simulcast to provide service over large areas or in hard to cover places, such as deep inside buildings. With simulcast, transceivers at multiple remote sites simultaneously transmit the same signal using the same communication channel or carrier frequency. As communication units, such as portable or mobile radios, move over the area covered by the wireless communication system, they are able to receive the signal from one or more of the remote site transceivers. Because of the overlap of the areas covered by each of the remote sites, there is a high probability that the communication units will be able to successfully receive the signal.

Generally, each remote site in a simulcast communication system is coupled to a central radio system collection and distribution point (also referred to as a prime site). When a communication unit is transmitting, transceivers at each remote site in range of the communication unit receive the transmitted signal and transport it to the prime site where a signal comparator then selects the best signal from all the sites. The signal selected as the best is distributed from the prime site back to the remote sites for simultaneous re-transmission.

To accurately transmit the outgoing signal, communication systems also typically use a timing reference to synchronize transmission by each of the remote sites. Each packet of information is individually sent from the prime site to the remote sites and associated with a transmission time. Each remote site then uses the transmission time to determine the specific transmission time for each packet of information to be sent over the air to a communication unit in the simulcast system.

The current approach is efficient for transmission of frequency division multiple access (FDMA) communications in a simulcast system, however, the current approach may be inefficient for TDMA communications in a simulcast system. For example, in a TDMA system where the frequency carrier bands are divided into multiple timeslots, packets of information (i.e., bursts) for each timeslot may require a separate transmission time. Additionally, individually packaging and transmitting each packet of information for each timeslot requires significant amounts of processing time and overhead signaling.

Accordingly, there is a need for a system and method for forming a TDMA frame in a simulcast system.

### BRIEF DESCRIPTION OF THE FIGURES

Various embodiment of the invention are now described, by way of example only, with reference to the accompanying figures.

FIG. 1 shows an embodiment of a simulcast communication system according to the present invention.

FIG. 2 shows an example of a plurality of TDMA frames according to the present invention.

FIG. 3 shows an embodiment of a process for forming a TDMA frame using bundles according to the present invention.

FIG. 4 shows a first example of a TDMA frame bundled into a single bundle according to the present invention.

FIG. 5 shows a second example of a TDMA frame that is segmented into two bundles according to the present invention.

FIG. 6 shows a third example of a TDMA frame that is segmented into four bundles according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present invention. Also, common but well-understood elements that are useful or necessary in a commercially feasible embodiment are not often depicted in order to facilitate a less obstructed view of these various embodiments of the present invention. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE INVENTION

A system and method for forming a TDMA frame in a simulcast system is disclosed. In particular, a prime site is coupled, via a network, to a plurality of remote sites, console sites, and a zone controller. When TDMA communications are received at the network from any of the various remote sites or console sites, the received TDMA communications are routed to the prime site. In one embodiment, the prime site forms bundles of bursts and sub-slot information for each TDMA frame from the received communications. One bundle for the TDMA frame (typically the first bundle) comprises a single transmission time for the transmission of the entire TDMA frame to a communication unit, regardless of the number of bundles generated to form the TDMA frame. All of the bundles that form the TDMA frame are sent to a plurality of remote sites. Based on the single transmission time, all of the bursts and sub-slot information in the TDMA frame are simultaneously transmitted by the plurality of remote sites to a communication unit in the simulcast system. In other embodiments, a plurality of transmission times may be generated and sent to the plurality of remote sites in different bundles for the TDMA frame. Let us now discuss the present invention in greater detail by referring to the figures below. For clarity and exemplary purposes only, the following description and examples assume a TDMA simulcast system, however, other types of simulcast systems, e.g., mixed FDMA/TDMA systems, may be used.

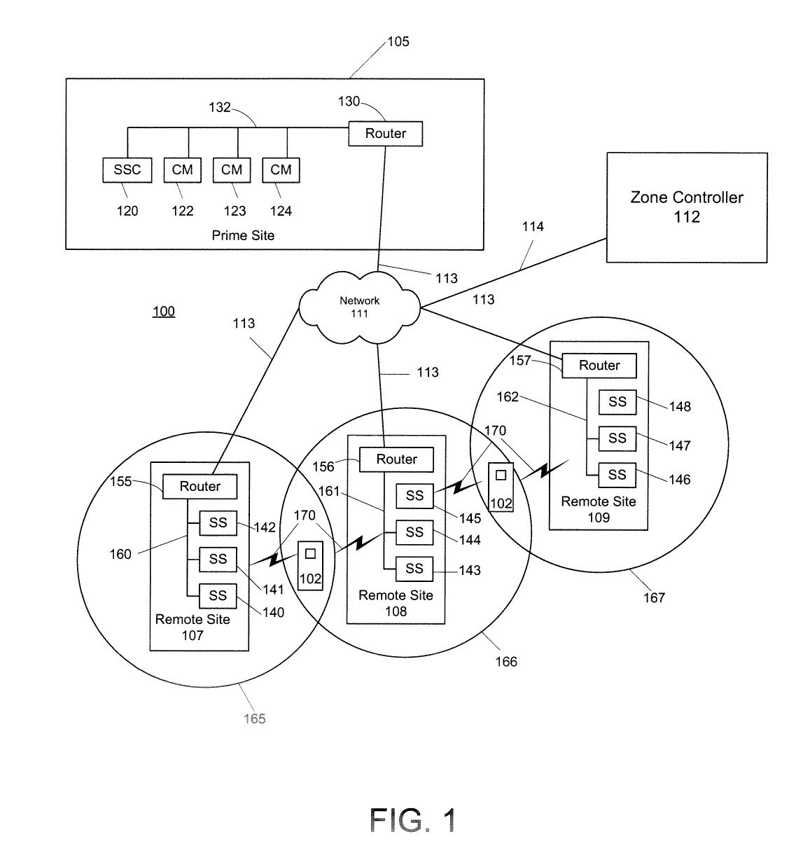

FIG. 1 shows one embodiment of a communication system 100 that supports simulcast communication to a plurality of communication units 102 according to the present invention. The communication units 102 may be mobile or portable wireless radio units, cellular radio/telephones, video terminals, portable computers with wireless modems, or any other wireless devices.

As shown in FIG. 1, the illustrated system 100 includes a prime site 105, three remote sites 107-109, a network 111, and a zone controller 112. The prime site 105, remote sites 107-109 and network 111 are interconnected by a plurality of site links 113. The site links 113 may include T1 lines, E1 lines, fiber optic lines, wireless links, or other suitable means for transporting data between the prime site 105 and remote sites 107-109.

The remote sites 107-109 include routers 155-157 and fixed position transceivers, referred to herein as simulcast stations (SS) 140-148. Each of the routers 155-157 is coupled to the various simulcast stations 140-148 at each remote site 107-109 via a local area network (“LAN”). For example, the simulcast stations 140-142 at the remote site 107 are connected to the router 155 by a LAN 160; the simulcast stations 143-145 at the remote site 108 are connected to the router 156 by a LAN 161; and the simulcast stations 146-148 at the remote site 109 are connected to the router 157 by a LAN 262.

The simulcast stations 140-148 at each remote site 107-109 provide radio coverage using wireless communication resources 170 to respective coverage areas 165-167. The wireless communication resources 170 used by the simulcast stations 140-148 and the communication units 102 may comprise radio frequency (RF) technologies, including, but not limited to code division multiple access (CDMA), TDMA, FDMA, infrared, Bluetooth, or any other type of wireless communication standard or protocol.

In general, the coverage areas 165-167 for each remote site 107-109 overlap so that the communication units 102 may receive and transmit radio signals to and from the simulcast stations 140-148 at more than one of the remote sites 107-109. Although FIG. 1 shows only two remote sites overlapping at any one time, it will be understood that a geographic location may include any number of overlapping remote site coverage areas.

The prime site 105 also contains equipment for controlling and conducting the simulcast communication. In particular, the prime site 105 includes a simulcast site controller (SSC) 120 and a plurality of comparators (CM) 122-124 linked to a router 130 by a LAN 132.

The prime site 105 and the associated remote sites 107-109 together are referred to as a simulcast site. Within the simulcast site, each of the comparators 122-124 is grouped with selected simulcast stations 140-148 at each of the remote sites 107-109 to form a simulcast channel. For example, a first simulcast channel may comprise a first comparator 122, a first simulcast station 142 at a first remote site 107, a second simulcast station 145 at a second remote site 108 and a third simulcast station 148 at a third remote site 109. The simulcast stations of a simulcast channel are also configured to use the same wireless communication resource.

The zone controller 112 may be located at the prime site 105, one of the remote sites 107-109, or elsewhere in the system 100. The zone controller 112 and network 111 are interconnected by a link 114 which may be selected from, but not limited to, a T1 line, an E1 line, a fiber optic line, or other suitable means for transporting data between the zone controller 112 and the prime site 105 via the network 111. The zone controller 112 assigns the channels and TDMA timeslots within the wireless communication system. The zone controller 112 also instructs the prime site 105 which channels and TDMA timeslots to use for each communication stream.

Although one embodiment of a communication system 100 is shown in FIG. 1, it will be appreciated that the wireless communication system 100 may also contain many other elements. For example, the communication system 100 may contain other simulcast sites. Each of the other simulcast sites may comprise a prime site and a plurality of remote sites. The elements of the prime site, such as the comparators and simulcast site controller, may be combined with one of the remote sites to form a combined remote/prime site. The communication system 100 may also contain other types of sites, such as repeater sites, that reuse the communication resources on a site-by-site basis instead of using simulcast communication (i.e., such as in a cellular communication system) or console sites that contain one or more dispatch consoles.

Additionally, the communication system 100 may also be linked to a public switched telephone network (PSTN) via a telephone gateway, a paging network or short message system via a paging gateway, and/or a facsimile machine or similar device via a fax gateway or modem. The communication system 100 may also be connected via a gateway to a number of additional content sources, such as the Internet or various Intranets.

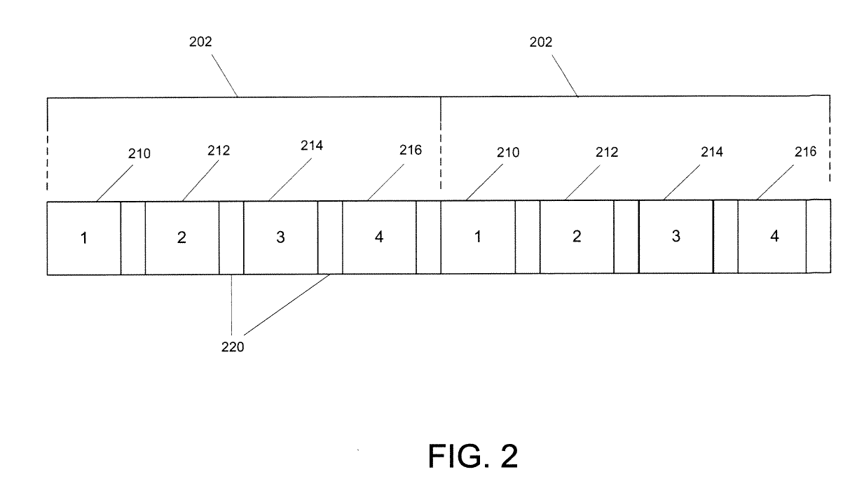

FIG. 2 illustrates one embodiment of a TDMA frame that may be used for transmitting voice call information in the system of FIG. 1. Generally, a TDMA frame is divided into a plurality of timeslots and sub-slots. To best describe the present invention, a TDMA frame with four timeslots and four sub-slots is illustrated in FIG. 2. However, it is understood that the TDMA frame may comprise a different number of timeslots. For example, TDMA simulcast systems currently being developed use a 2-timeslot TDMA frame. The present invention may also be used with TDMA frames having more than 4 timeslots, such as 8, 16 or any other potential number of timeslots.

As shown in FIG. 2, the 4-timeslot TDMA frame 202 is divided into four separate timeslots, which are respectively labeled as “1”, “2”, “3”, and “4”. Each timeslot is then further divided into discrete information packets (also referred to as “bursts”) 210-216 corresponding to a specific amount of information. For example, each burst 210-216 in a Motorola ASTRO TDMA compliant system is approximately 27.5 ms long and represents about 60 ms of voice information.

If no communication is assigned to the timeslot, an unassigned timeslot indication is contained in the data for that timeslot. Previously in FDMA communications systems, if there was no information for the simulcast stations to transmit, the simulcast stations simply did not transmit anything to the communication unit. With TDMA communications systems, however, it is common for one or more of the timeslots within the slotted frame to be idle or unassigned to a communication. Accordingly, in a TDMA simulcast system, the comparator includes an “idle” message for the simulcast station to transmit to the communication unit 102 in the unassigned timeslot in accordance with the present invention.

The bursts 210 from a first TDMA communication assigned to a first timeslot 1, the bursts 212 from a second TDMA communication assigned to a second timeslot 2, the bursts 214 from a third TDMA communication assigned to a third timeslot 3, and the bursts 216 from a fourth TDMA communication assigned to a fourth timeslot 4 are interleaved and offset in time such that only bursts from a single TDMA communication assigned to a single timeslot are transmitted at any one time. Thus, in this example, a single TDMA frame 202 comprises one burst from each TDMA communication assigned to timeslots 1-4.

Sub-slots 220 are also provided between each of the timeslots in the TDMA frame. For outbound signals, the sub-slots 220 typically include a common announcement channel (CACH) signal for channel management as well as low speed signaling. The type of sub-slot information generated and carried in the sub-slots 220 for the outbound frame is commonly known in the art and will not be discussed in great detail.

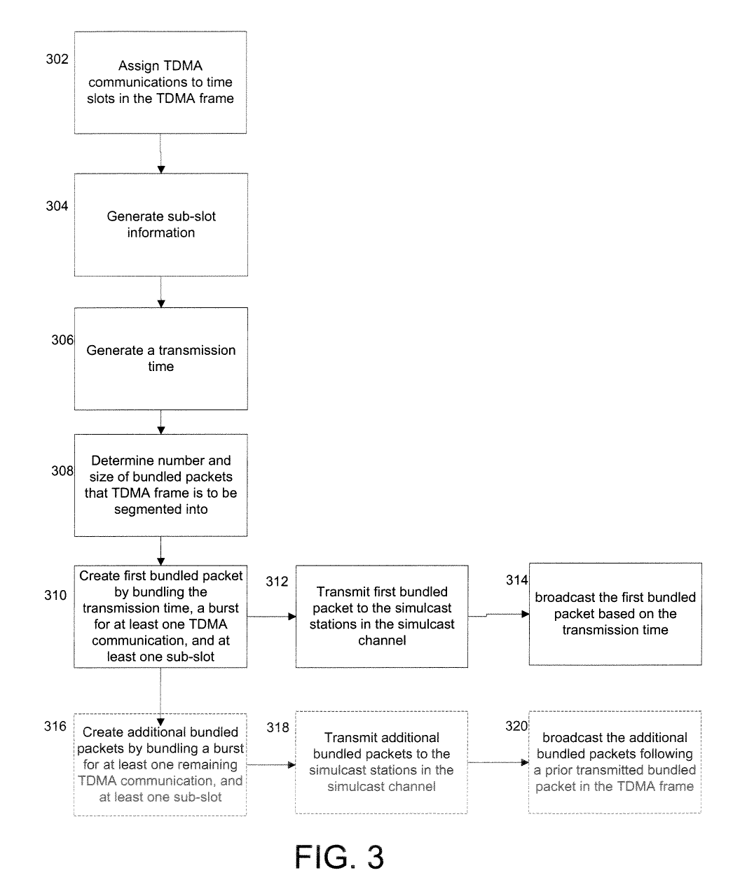

FIG. 3 illustrates one embodiment of a method for forming a TDMA frame in the 4-slot TDMA simulcast system as illustrated in FIG. 2. TDMA communications are assigned to a particular timeslot on a simulcast channel in step 302. In one embodiment, this is accomplished by a channel grant being sent from the zone controller 112 to the prime site 105. Thus, for example, a first communication grant may be sent from the zone controller 112 to assign a first TDMA communication to a first of the four TDMA timeslots 1-4, a second communication grant may be sent from the zone controller 112 assigning a second TDMA communication to a second timeslot, a third communication grant may be sent from the zone controller 112 assigning a third TDMA communication to a third timeslot, and a fourth communication grant may be sent from the zone controller 112 assigning a fourth TDMA communication to a fourth timeslot.

The TDMA communications may originate from various components in the communication system 100, including communication units 102, remote sites 107-109, console sites (not shown) or any other component capable of transmitting signals to the network 111. However, it should be understood that if a single TDMA communication is received from several different simulcast stations 140-148, a process known as voting may be used to create a resultant communication from the multiple received TDMA communications. For example, a voting comparator at the prime site 105 may compare each of the TDMA communications received from the different simulcast stations 140-148 and then choose one of the communications as a “best.” The voting comparator may also combine the communications from the different simulcast stations 140-148 on the associated simulcast channel to form a combined communication.

The comparator 122 generates sub-slot information to be transmitted in the plurality of sub-slots in the TDMA frame 202 in step 304. As noted above, the sub-slot information may be CACH signals, and may include information either specific to a particular burst or TDMA communication, or general information for the entire TDMA frame. In one embodiment, the sub-slot information is transmitted with each TDMA frame and is divided equally among the number of sub-slots available in the TDMA frame. For example, in a 4-slot TDMA frame having 4 sub-slots, the sub-slot information is divided into four equal portions, where each portion is transmitted on one of the four sub-slots.

In step 306, the comparator 122 also generates a transmission time that is used to ensure that the frames in the TDMA communication are transmitted simultaneously by each simulcast station in the simulcast channel. Various known processes for producing a transmission time may be employed. For example, the transmission time may be representative of a launch time for a timeslot, a bundled packet, or TDMA frame for each simulcast station 140-148 in the simulcast channel. This may be accomplished by experimentally determining a propagation delay between each of the simulcast stations 140-148 in the simulcast channel and the prime site 105. The transmission time is then set based on the simulcast station with the greatest delay plus some additional time to account for processing, thus ensuring that all simulcast stations in the simulcast channel will have the data to be transmitted in their respective buffers before the transmission time occurs. Alternatively, the transmission time may also correspond to the time at which the data is transmitted from the prime site 105. Each simulcast station may then individually determine the actual transmission time based on the propagation delays for each particular simulcast station. These and other methods for using a transmission time in a simulcast communication system are well-known and the present invention is not meant to be limited to any one specific methodology.

In step 308, the comparator 122 determines the number of bundles that an outbound TDMA frame is to be segmented into, along with the size of each bundle. For example, in a 4-slot TDMA signal, each outbound TDMA frame may be in a single bundle having a burst for each of the four TDMA communications, or segmented into four separate bundles where each of the four separate bundles includes a single burst for each of the four respective TDMA communications, or segmented into two bundles each corresponding to two TDMA communications, or segmented into any other possible combination.

The specific number and size of the bundle for each outbound TDMA frame may be chosen based on various factors and the desired operation of the system. Thus, it should be noted that the bundles need not contain the same number of timeslots and sub-slot as other bundles for the TDMA frame. For example, bundling the bursts for a greater number of TDMA communications together in each bundle decreases the total number of packets transmitted across the system as well as the total overhead signaling required for transmitting the packets, while bundling a lesser number of bursts together may minimize throughput delay in the system.

In one embodiment, the number and size of the bundles for each outbound TDMA frame may be preset for a simulcast system and/or simulcast channel by a user or network administrator. Alternatively, the number and size of the bundles may also be automatically and continuously altered by the comparator for each TDMA signal and/or TDMA frame by assessing the then current condition of the system or the characteristics and requirements of a particular received TDMA communication.

In step 310, the first comparator 122 at the prime site 105 creates a first bundle by bundling or multiplexing the transmission time, a burst for at least one of the TDMA communications assigned to a timeslot in the TDMA signal, and at least one sub-slot. In one embodiment, the number of sub-slots in a bundle is equal to the number of bursts in the bundle.

The first bundle is transmitted to the simulcast stations in the simulcast channel in step 312 in preparation for transmission of the TDMA frame to a communication unit in the simulcast system. The first bundle is then broadcast from the simulcast stations based on the transmission time in step 314.

If the outbound TDMA frame is to be segmented into more than one bundle, additional bundles for the outbound TDMA frame are generated in step 316. Each additional bundle may include a burst from at least one of the remaining TDMA communications, and at least one sub-slot. During the bundling process for a TDMA frame, the bursts are bundled in the order that they are to be broadcast from the simulcast stations in the simulcast channel. Thus, the bursts from the TDMA communication assigned to the first timeslot 1 are bundled before the bursts from the TDMA communication assigned to the second timeslot 2, which are bundled before the burst from the TDMA communication assigned to the third timeslot 3, and so on. As mentioned earlier, if a given timeslot is not assigned for a TDMA communication, an idle message to be transmitted in the unassigned timeslot is bundled instead.

In one embodiment, the additional bundles formed in step 316 do not include another transmission time as the broadcast of the additional bundles are synchronized by broadcasting the bursts from the additional bundle during TDMA timeslots immediately following the transmitted bursts from the first bundle (or a prior additional bundle). In another embodiment, however, a transmission time may alternatively be bundled with each bundle in the TDMA frame. In this instance, the transmission time for each bundle may correspond to a distinct launch time for the first timeslot in the respective bundle. However, each bundle may also be bundled with the same transmission time, in which case each particular simulcast station may be configured to determine the launch time for each particular bundle based on the delay between that bundle and the first bundle in the TDMA frame.

If an additional bundle is created in step 316, the additional bundle is transmitted to the simulcast stations in the simulcast channel in step 318. The additional bundle is then broadcast from the simulcast stations in step 320. Each subsequent outbound TDMA frame in the TDMA signal is then similarly bundled using the above process.

Although the flowchart in FIG. 3 has been described with the assumption that there are sufficient TDMA communications to be assigned to each timeslot in the TDMA frame, it is understood that timeslots in the TDMA frame may also be unassigned. For example, if only three TDMA communications are being transmitted on a 4-timeslot TDMA frame, one timeslot in the TDMA frame is unassigned. In this case, an idle message is transmitted on the unassigned timeslot. The bursts for the unassigned timeslot containing the idle message are bundled in a similar fashion to the process described above for timeslots assigned to a TDMA communication. The generated sub-slot information, however, remains distributed among all the available sub-slots even if a timeslot is unassigned. Thus, in one embodiment, the portions of the sub-slot information continue to be transmitted on each sub-slot in the TDMA frame even if there is an idle message transmitted on an unassigned timeslot.

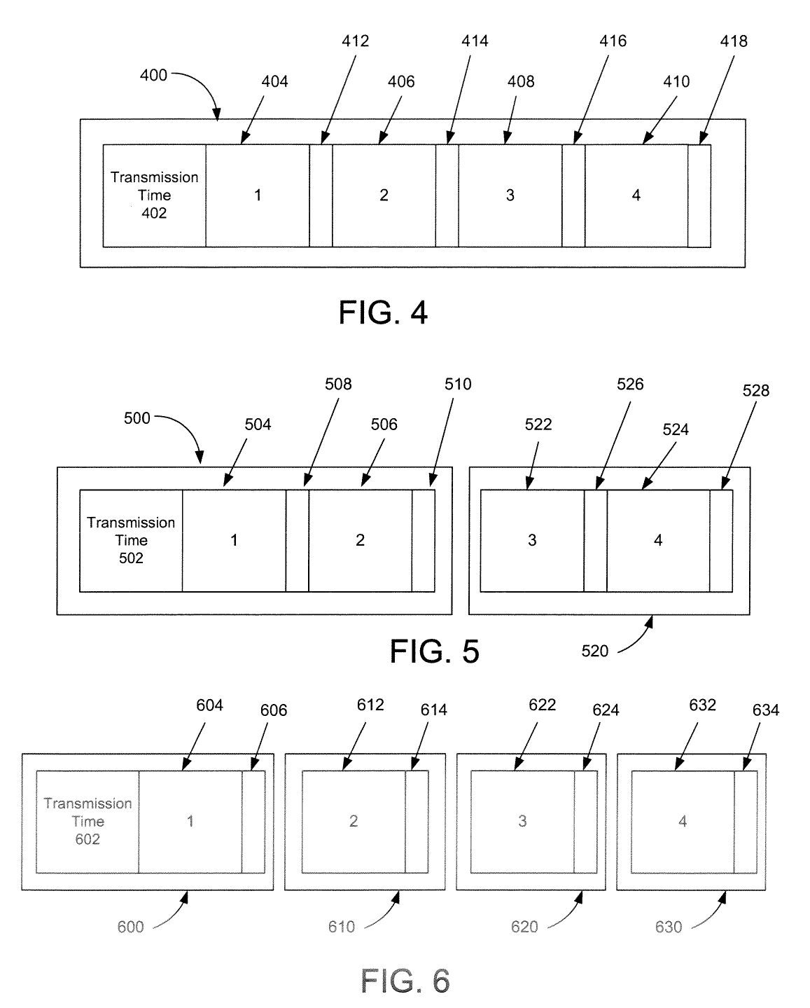

Three examples of segmenting an outbound TDMA frame into at least one bundle are illustrated in FIGS. 4-6. In FIG. 4, the illustrated outbound TDMA frame is bundled into a single bundle 400. The bundle 400 includes a transmission time 402, a first burst 404 from a first TDMA communication assigned to a first timeslot 1, a second burst 406 from a second TDMA communication assigned to a second timeslot 2, a third burst 408 from a third TDMA communication assigned to a third timeslot 3, and a fourth burst 410 from a fourth TDMA communication assigned to a fourth timeslot 4. The bundle 400 also includes sub-slot information to be transmitted in the four sub-slots 412-418 in the TDMA frame.

As discussed above, if four TDMA communications are assigned to the 4-timeslot TDMA frame, a burst from each communication 404-410 is transmitted in the appropriate assigned timeslot. The specific timeslot assignment for each TDMA communication is determined by a channel grant sent from the zone controller 112.

If less than four TDMA communications are assigned to the four timeslots in the 4-timeslot TDMA frame, then at least one of the timeslots will remain unassigned. For example, if only three TDMA communications are assigned to the 4-timeslot TDMA frame, the three TDMA communications may be assigned to timeslots 1, 2 and 3 while timeslot 4 remains unassigned. Of course, the three TDMA communications may also be assigned to timeslots 1, 2, and 4; timeslots 1, 3, and 4; timeslots 2, 3 and 4; or any other combination. The unassigned timeslot transmits an idle message rather than a burst from an assigned TDMA communication.

FIG. 5 illustrates an example of an outbound TDMA frame that is segmented into two bundles. In this embodiment, a first bundle 500 includes a transmission time 502, a first burst 504 from a first TDMA communication assigned to a first timeslot 1, a second burst 506 from a second TDMA communication assigned to a second timeslot 2, and portions of the sub-slot information to be transmitted in the two sub-slots 508-510. The second bundle 520 includes a third burst 522 from a third TDMA communication assigned to a third timeslot 3, a fourth burst 524 from a fourth TDMA communication assigned to a fourth timeslot 4, and portions of the sub-slot information to be transmitted in the two sub-slots 526-528.

FIG. 6 then illustrates an example of an outbound TDMA frame that is segmented into four bundles. In this embodiment, a first bundle 600 comprises a transmission time 602, a first burst 604 from a first TDMA communication assigned to a first timeslot 1, and a portion of the sub-slot information to be transmitted in a first sub-slot 606. The second bundle 610 comprises a second burst 612 from a second TDMA communication assigned to a second timeslot 2, and a portion of the sub-slot information to be transmitted in a second sub-slot 614. The third bundle 620 comprises a third burst 622 from a third TDMA communication assigned to a third timeslot 3, and a portion of the sub-slot information to be transmitted in a third sub-slot 624. The fourth bundle 630 comprises a fourth burst 632 from a fourth TDMA communication assigned to a fourth timeslot 4, and a portion of the sub-slot information to be transmitted in a fourth sub-slot 634.

As with the embodiment shown in FIG. 4, it is understood that each of the bursts for the four timeslots in FIGS. 5 and 6 may comprise either a portion of an assigned TDMA communication or an idle message if the timeslot is unassigned. Thus, it is possible that a bundle may include only idle messages and sub-slots.

Of course, while three exemplary bundling arrangements are shown, it is understood that other configurations of bundles may also be used. For example, assume that x number of communications are assigned to x number of timeslots in the plurality of timeslots in the TDMA frame, wherein x is a positive integer that is equal to or less than a number of timeslots in the plurality of timeslots. A bundle, for example, can be formed with a burst from each of x number of communications to be transmitted in their assigned timeslot; or a first bundle can be configured with a burst from each of y number of communications to be transmitted in their assigned timeslots, and a second bundle can be configured with a burst from each of z number of communications to be transmitted in their assigned timeslots, wherein y and z are positive integers that are less than x, and wherein a sum of y and z is equal to or less than x; or any number of bundles can be formed for the TDMA frame in a similar manner and remain within the scope of the present invention.

Each bundle for the TDMA frame may vary in length (e.g., based on the bundling decisions made by the comparator and/or by combining the transmission times with specific bundles). Additionally, the order and structure of the information in the bundles may be altered based on the standards and protocols of a particular communication system. The information contained in the bundles may also be compressed or encrypted.

Furthermore, it also understood that if the TDMA signal is divided into a different number of timeslots, then different combinations of bundling arrangements would be available. For example, in a 2-timeslot TDMA signal, an outbound TDMA frame may be segmented into one bundle having a burst from each of the TDMA communications assigned to the two timeslots, or two separate bundles each having one burst from each of the TDMA communications. In an 8-timeslot TDMA signal, a bundle may include bursts from between one and eight of the TDMA communications respectively assigned to the eight timeslots in the TDMA frame. Thus, as a general rule, an outbound TDMA frame in an N-timeslot TDMA signal (where N is any integer) may be segmented into bundles having bursts from between 1 and N number of TDMA communications.

By means of the aforementioned invention, multiple bursts and sub-slot information transmitted in the same TDMA frame 202 may be bundled together and assigned a single transmission time. This allows the transmission of information within a simulcast system using less overhead than a traditional system. Additionally, by decreasing the total number of individual packets being transmitted across the system by the use of bundling, the present invention may be used to decrease the link bandwidth between the prime site and the remote sites.

Further advantages and modifications of the above described system and method will readily occur to those skilled in the art. The invention, in its broader aspects, is therefore not limited to the specific details, representative system and methods, and illustrative examples shown and described above. Various modifications and variations can be made to the above specification without departing from the scope or spirit of the present invention, and it is intended that the present invention cover all such modifications and variations provided they come within the scope of the following claims and their equivalents.

What is claimed is:

1. A method for efficiently forming a time division multiple access (TDMA) frame for transmission in a simulcast system, wherein the TDMA frame comprises a plurality of timeslots and sub-slots, the method comprising the steps of, at a prime site:
receiving a first communication grant that assigns a first communication to a first timeslot from the plurality of timeslots in the TDMA frame;
generating a transmission time for the first timeslot in the TDMA frame;
generating sub-slot information to be transmitted in the plurality of sub-slots;
forming a first bundle which includes the transmission time, a burst from the communication to be transmitted in the first timeslot, and a portion of the sub-slot information to be transmitted in a first sub-slot; and
sending the first bundle to a plurality of remote sites in preparation for transmission of the TDMA frame to a communication unit in the simulcast system.

2. The method of claim 1 further comprising the step of receiving a second communication grant that assigns a second communication to a second timeslot from the plurality of timeslots in the TDMA frame, and wherein the first bundle further includes a burst from the second communication to be transmitted in the second timeslot and a portion of the sub-slot information to be transmitted in a second sub-slot.

3. The method of claim 2 wherein the first bundle further includes an idle message for a timeslot in the plurality of timeslots that is not assigned to a communication.

4. The method of claim 1 further comprising the step of forming a second bundle which includes an idle message for a timeslot from the plurality of timeslots that is not assigned to a communication.

5. The method of claim 1 wherein the first bundle includes an idle message for a timeslot in the plurality of timeslots that is not assigned to a communication.

6. The method of claim 1 further comprising the steps of:
receiving a second communication grant that assigns a second communication to a second timeslot from the plurality of timeslots in the TDMA frame;
forming a second bundle which includes a burst from the second communication to be transmitted in the second timeslot and a portion of the sub-slot information to be transmitted in a second sub-slot; and
sending the second bundle to a plurality of remote sites in preparation for transmission of the TDMA frame to the communication unit in the simulcast system.

7. The method of claim 1 further comprising the steps of:
receiving a second communication grant that assigns a second communication to a second timeslot from the plurality of timeslots in the TDMA frame;
generating a second transmission time for the second timeslot in the TDMA frame;
forming a second bundle which includes the second transmission time, a burst from the second communication to be transmitted in the second timeslot and a portion of the sub-slot information to be transmitted in a second sub-slot; and
sending the second bundle to a plurality of remote sites in preparation for transmission of the TDMA frame to the communication unit in the simulcast system.

8. The method of claim 2 further comprising the steps of:
receiving a third communication grant that assigns a third communication to a second timeslot from the plurality of timeslots in the TDMA frame;
forming a second bundle which includes a burst from the third communication to be transmitted in the third timeslot and a portion of the sub-slot information to be transmitted in a third sub-slot; and
sending the second bundle to a plurality of remote sites in preparation for transmission of the TDMA frame to the communication unit in the simulcast system.

9. The method of claim 1 wherein the steps are performed by a comparator at the prime site.

10. The method of claim 1 wherein the transmission time represents a time for broadcasting the first bundle from each of the plurality of remote sites.

11. The method of claim 1 wherein the second transmission time represents a time for broadcasting the second bundle from each of the plurality of remote sites.

12. The method of claim 1 wherein the sub-slot information comprises a common announcement channel signal.

13. A method for efficiently forming a time division multiple access (TDMA) frame for transmission in a simulcast system, wherein the TDMA frame comprises a plurality of timeslots and sub-slots, the method comprising the steps of, at a prime site:
receiving x number of communication grants that assigns x number of communications to x number of timeslots in the plurality of timeslots in the TDMA frame;
generating a transmission time for a first timeslot in the TDMA frame;
generating sub-slot information to be transmitted in the plurality of sub-slots;
forming a first bundle which includes the transmission time, a burst from each of x number of communications to be transmitted in their assigned timeslot, and at least a portion of the sub-slot information to be transmitted in x number of sub-slots; and
sending the first bundle to a plurality of remote sites in preparation for transmission of the TDMA frame to a communication unit in the simulcast system,
wherein x is a positive integer that is equal to or less than a number of timeslots in the plurality of timeslots.

14. The method of claim 13 wherein the first bundle includes an idle message for a timeslot in the plurality of timeslots that is not assigned to a communication.

15. The method of claim 13 wherein the first bundle includes an idle message for each timeslot in the plurality of timeslots that is not assigned to a communication.

16. A method for efficiently forming a time division multiple access (TDMA) frame for transmission in a simulcast system, wherein the TDMA frame comprises a plurality of timeslots and sub-slots, the method comprising the steps of, at a prime site:
receiving x number of communication grants that assigns x number of communications to x number of timeslots in the plurality of timeslots in the TDMA frame;
generating a transmission time of a first timeslot in the TDMA frame;
generating sub-slot information to be transmitted in the plurality of sub-slots;
forming a first bundle which includes the transmission time, a burst from each of y number of communications to be transmitted in their assigned timeslot, and a portion of the sub-slot information to be transmitted in y number of sub-slots;
forming at least a second bundle which includes a burst from each of z number of communications to be transmitted in their assigned timeslots, and a portion of the sub-slot information to be transmitted in z number of sub-slots; and
sending the first bundle and at least the second bundle to a plurality of remote sites in preparation for transmission of the TDMA frame to a communication unit in the simulcast system,
wherein x is a positive integer that is equal to or less than a number of timeslots in the plurality of timeslots, and wherein y and z are positive integers that are less than x, and wherein a sum of y and z is equal to or less than x.

17. The method of claim 16 wherein, if x is less than the number of timeslots in the plurality of timeslots, at least one of the first bundle or second bundle includes an idle message for a timeslot in the plurality of timeslots that is not assigned to a communication.

18. The method of claim 16 further comprising the step of generating a second transmission time for the second bundle, and wherein the second bundle further includes the second transmission time.

19. The method of claim 18 wherein the second transmission time represents a time for broadcasting the second bundle from each of the plurality of remote sites.

20. The method of claim 16 wherein the transmission time represents a time for broadcasting the first bundle from each of the plurality of remote sites.

21. A simulcast system capable of efficiently forming a time division multiple access (TDMA) frame, wherein the TDMA frame comprises a plurality of timeslots and sub-slots, the simulcast system comprising:
a router to receive a plurality of communications from a network;
a zone controller configured to assign each of the plurality of communications to one of the plurality of timeslots in the TDMA frame; and
a comparator configured to generate a transmission time for a first timeslot in the TDMA frame, generate sub-slot information to be transmitted in the plurality of sub-slots, and form a first bundle which includes the transmission time, a burst from each of x number of communications to be transmitted in their assigned timeslot, and at least a portion of the sub-slot information to be transmitted in x number of sub-slots; and
wherein x is a positive integer that is equal to or less than a number of timeslots in the plurality of timeslots.

22. The system of claim 21 wherein the comparator is further configured to form a second bundle which includes a burst from each of y number of communications to be transmitted in their assigned timeslot, and at least a portion of the sub-slot information to be transmitted in x number of sub-slots;
wherein y is a positive integer, and wherein a sum of y and x is equal to or less than the number of timeslots in the plurality of timeslots.
